(19) United States
(12) Patent Application Publication
(10) Pub. No.: US 2016/0153154 A1
(43) Pub. Date: Jun. 2, 2016

(54) TENNIS COURT PREPARATION DEVICE

(71) Applicant: REDEXIM HANDEL - EN EXPLOITATIE MAATSCHAPPIJ B.V., AC Zeist (NL)

(72) Inventor: Cornelius Hermanus Maria DE BREE, AC Zeist (NL)

(21) Appl. No.: 14/904,323

(22) PCT Filed: Jul. 7, 2014
(86) PCT No.: PCT/EP2014/064475

§ 371 Date: Jan. 11, 2016

(30) Foreign Application Priority Data
Jul. 11, 2013 (DE) 20 2013 006 230.4

(51) Int. Cl. E01C 23/082; B60D 1/04; B60D 1/36

(52) U.S. Cl. CPC E01C 23/082; B60D 1/36; B60D 1/04

(57) ABSTRACT

A tennis court preparation device for scraping tennis court surfaces, which can be pulled across a tennis court in a direction of travel by a traction vehicle, including at least one frame and at least one support device for supporting the frame on the tennis court surface that is to be prepared. At least one coupling system for coupling to a traction vehicle, and at least two main scraper elements connected to the frame, which are linked to each other in such a way that the gap between the two main scraper elements tapers in the direction opposite to the direction of travel, leaving a space between the two main scraper elements at the rear ends of the main scraper elements as seen looking in the direction of travel, so that the scraped-off tennis court surface material is left in a trail formed by the space.

The invention relates to a tennis court preparation device according to the precharacterizing part of claims 1, 7 and 12, and a coupling device according to claim 13.

In cinder courts for tennis, it is necessary in springtime prior to the start of the playing season that the tennis courts, particularly the tennis court surface, are prepared and refurbished. The tennis court surface preferably comprises a pourable material of fine-grained consistency such as e.g. brick dust. In most cases, for preparation and refurbishing, the top layer of the tennis court surface will be loosened and be scraped off and respectively removed. The removed material will then be carried off the tennis court with the aid of flat shovels or brick-dust shovels. Subsequently, uneven spots will be eliminated and new tennis court surface layers will be applied and then will be compacted e.g. by rolls.

For preparation and refurbishing, use is frequently made of simple, manually operated smoothing boards, street brooms, brick-dust shovels and tennis court rolls. Consequently, preparation and refurbishing is very time-consuming and labor-intensive.

Thus, it is an object of the present invention to provide tennis court preparation devices by which the refurbishing and preparation of tennis court surfaces can be carried out in a simplified and faster manner.

The above object is achieved by the features defined in claims 1, 7, 12 and 13.

According to the invention, in a tennis court preparation device for scraping tennis court surfaces, which can be towed across a tennis court in a direction of travel by a traction vehicle, comprising at least one frame and at least one support device for supporting the frame on the tennis court surface that is to be prepared, the following features are advantageously provided:
at least one coupling device for coupling to a traction vehicle,
at least two main scraper elements connected to the frame, which are arranged relative to each other in such a way that the distance between the two main scraper elements tapers in the direction opposite to the direction of travel,
a gap is left between the two main scraper elements at the rear ends of the main scraper elements as viewed in the direction of travel, so that the scraped-off tennis court surface material is left in a trail formed by the gap,
in front of the gap as viewed in the direction of travel, an additional scraper element is arranged, having a scraping width corresponding to at least the width of the gap.

The present tennis court preparation device for scraping tennis court surfaces has the advantage that, due to a provided coupling device, the tennis court preparation device can be pulled with the aid of a traction vehicle. Thus, the tennis court preparation device does not need to be manually operated. Further, because of the main scraper elements and also the additional scraper element, the tennis court will be scraped across the whole width of the tennis court preparation device. Further, it is advantageous that the scraped-off tennis court surface will remain lying in a trail formed by the gap. In this manner, the tennis court surface material can be collected in a very simple manner and is not distributed over the whole tennis court. This considerably facilitates the work of the groundskeeper.

The additional scraper element can extend substantially orthogonally to the direction of travel. The additional scraper element can extend orthogonally to the to-be-prepared tennis court. Alternatively, the additional scraper element can extend at such an angle to the tennis court to be prepared that, during movement in the direction of travel, the scraped-off tennis court surface material is caused to slide over the additional scraper element. In this manner, even in an additional scraper element extending substantially orthogonally to the direction of travel, the tennis court surface material will not be collected in the tennis court preparation device but can be left lying in the gap formed by the main scraper elements.

The additional scraper element can also extend relative to the direction of travel at an angle differing from 90°. Thus, the additional scraper element can be arranged obliquely so that the scraped-off tennis court surface material will be directed to the side.

The scraping depth can be settable by adjustment of the distance between the support device and the frame. For the quality of the tennis court, it is quite decisive to be able to set the scraping depth in an exact manner because only those portions of the upper tennis court surface material that are not adhering anymore shall be removed. In this manner, the tennis court can be restored to the effect that the tennis court surface material will be in a playable condition for a long time and will be firmly attached.

The invention makes it possible to set the scraping depth in a convenient manner.

Said at least one support device can be arranged between the main scraper elements. This way, the support device will contact the to-be-prepared tennis court prior to the scraping and thus cannot leave traces on the tennis court. Particularly, the support device can be arranged in that area which will be scraped by the two main scraper elements. Alternatively, the support device can also be arranged in the area which will be scraped by the additional scraper element.

The at least one support device can comprise two support elements. These two support elements can preferably be support skids. Alternatively, however, also wheels can be used as support elements.

The invention further advantageously provides a tennis court preparation device for collection of scraped-off tennis court surface material, said tennis court preparation device being towable in the direction of travel across a to-be-prepared tennis court by means of a traction vehicle, wherein said tennis court preparation device for collection of scraped-off tennis court surface material comprises the following features:
at least one collection bin which is delimited, laterally and in the rear area when viewed in the direction of travel, by at least one side wall,
said at least one side wall being slideable by an edge on the scraped-off tennis court,
the collection bin being open in the front area when viewed in the direction of travel, so that scraped-off material arranged in front of the collection bin when viewed in the direction of travel can be collected in the collection bin,
at least one coupling element for coupling to a traction vehicle,
at least one bar element connected to the collection bin, said bar element, when viewed in the direction of travel, extending forward beyond the collection bin to at least the coupling device, wherein, with the aid of the bar element, the collection bin is tiltable so that said edge of said at least one side wall in the rear area does not contact the to-be-prepared tennis court anymore.

The tennis court preparation device for collection of scraped-off material has the advantage of being towable by means of a traction vehicle and being operative to collect the tennis court surface material which has been deposited in a trail e.g. with the aid of the tennis court preparation device for scraping tennis court surfaces. Further, the tennis court preparation device for collection of scraped-off material has the advantage that, due to the provision of a bar element which, when viewed in the direction of travel, extends forward beyond the collection bin to at least the coupling device, a driver of the traction vehicle from his position on the seat will be able to tilt the collection bin, and the material collected in the collection bin can be left lying on a pile. This also will save work and time.

Preferably, the bar element, when viewed in the direction of travel, still extends beyond the coupling device so that this bar element can be operated conveniently by a traction vehicle driver seated on the traction vehicle.

There can be provided at least one tilting element which, when viewed in the direction of travel, is arranged laterally adjacent to the collection bin, wherein the collection bin, when tilted, can be supported on said at least one tilting element.

There can be provided two tilting elements in the tennis court preparation device for collection of scraped-off tennis court surface material, each of them being arranged, when viewed in the direction of travel, laterally adjacent to the collection bin, with a first of the two tilting elements being arranged on the first side of the collection bin and the second of the two tilting elements being arranged on the second side of the collection bin.

Said at least one tilting element can comprise at least two support faces, the first support face being in contact with the tennis court in the non-tilted state of the collection bin and the second support face being in contact with the tennis court in the tilted state of the collection bin.

The tennis court preparation device for collection of scraped-off tennis court surface material according to any one of claims 7 to 10 can be adapted for coupling to the tennis court preparation device for scraping tennis court surfaces according to any one of claims 1 to 6 with the aid of a coupling device. In this manner, the tennis court surface material that has been deposited in a trail by the tennis court preparation device for scraping tennis court surfaces can be collected directly by the tennis court preparation device for collection of scraped-off tennis court surface material. This can thus be performed in one working step.

The invention further advantageously provides a tennis court preparation device for preparing a tennis court, which is towable in the direction of travel across a tennis court by means of a traction vehicle. The tennis court preparation device for preparing a tennis court comprises the following features:
at least one frame,
at least one coupling element for coupling to the traction vehicle,
at least one support element connected to the frame,
at least two rows, arranged orthogonally to the direction of travel, of mutually adjacent knife elements which are connected to the frame and, when in a working position, are operative to pierce into the tennis court,
the piercing depth being settable by adjustment of the height between said at least one support element and the frame.

With the aid of such a device, it is rendered possible, after the top layer of the tennis court surface material has been removed, to generate slits in the tennis court. Thereby, the drainage effect of the tennis court can be improved. In this regard, it is also decisive to be able to set the piercing depth with precision and to vary it in accordance with the respective tennis court. This can be performed with the aid of the present device, which can be towed in a simple manner by means of a traction vehicle.

Preferably, there are provided at least four rows of mutually adjacent knife elements. The knife elements, arranged behind each other in the direction of travel, can be arranged exactly behind each other so that the knife elements arranged in the different rows will be guided in the same slit. Alternatively, the knife elements arranged behind each other can also be arranged at an offset relative to each other so that different slits will be generated by the knives of the different rows.

The invention further advantageously provides a coupling device for coupling a tennis court preparation device to a traction vehicle which can be driven across a tennis court to be prepared. Such a coupling device comprises particularly the following features:
a frame element adapted to be fastened to a traction vehicle,
a bar element connected to the frame element and extending substantially orthogonally to the tennis court,
an adjustment element connected to the bar element and being adjustable in height along the bar element, said adjustment element comprising a connection device adapted to have a tennis court preparation device coupled to it.

This has the advantage that, with the aid of such a coupling device, different tennis court preparation devices of a traction vehicle can be coupled. With the aid of this coupling device, the height of the connection device can be set and thus be optimally adapted to the respective tennis court preparation device. Thus, exchange of tennis court preparation devices that have to be towed is facilitated.

The bar element can be a threaded bar. The adjustment element can comprise a nut.

The bar element can be a hook element.

The invention further advantageously provides a traction vehicle comprising a coupling device according to any one of claims 13 to 16 fastened to the traction vehicle.

The invention further advantageously provides a system comprising a traction vehicle according to claim 17 and at least one tennis court preparation device according to any one of claims 1 to 12 coupled to the coupling device.

Exemplary embodiments of the invention will be explained in greater detail hereunder with reference to the drawings.

In the drawings, the following is schematically shown:

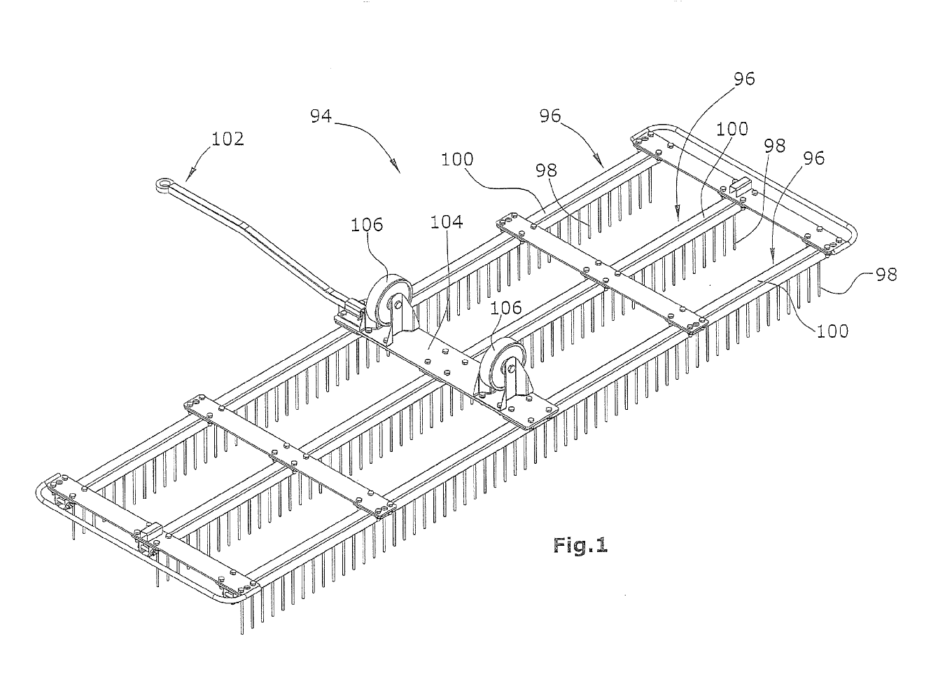

FIG. 1 shows a tennis court preparation device for loosening the top tennis court surface layer,

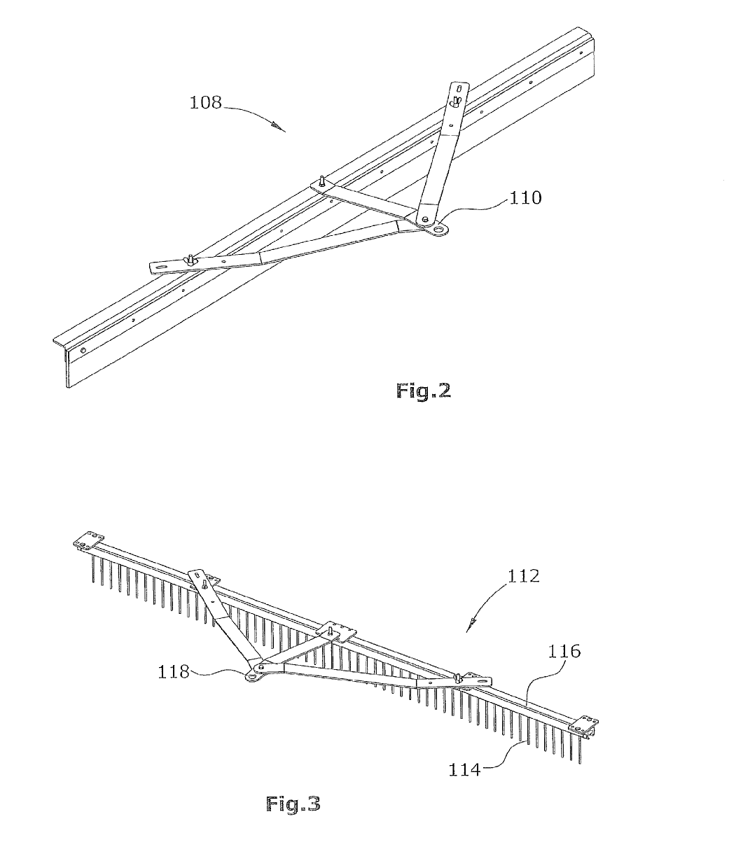

FIG. 2 shows a tennis court preparation device for cleaning the tennis court,

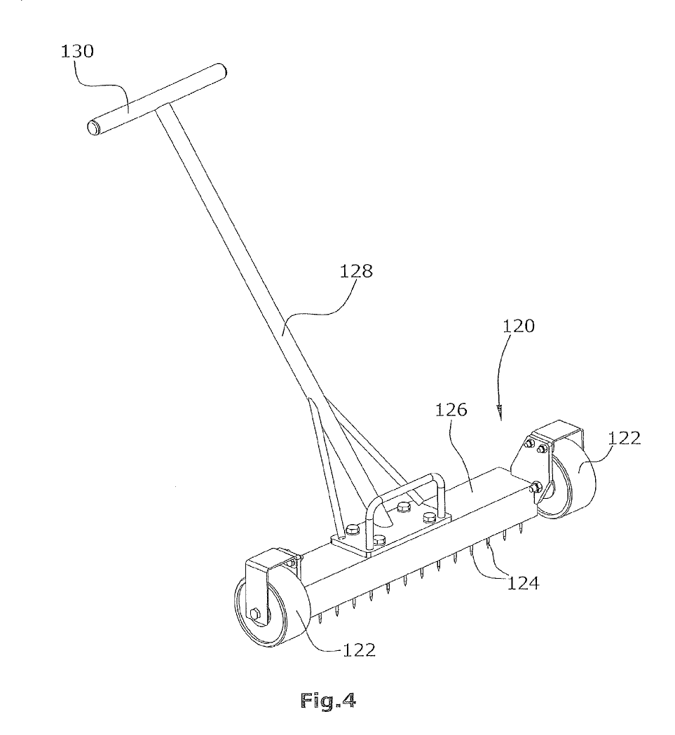

FIG. 3 shows a tennis court preparation device for loosening the top tennis-court surface layer,

FIG. 4 shows a tennis court preparation device for loosening a considerably compacted tennis court surface layer,

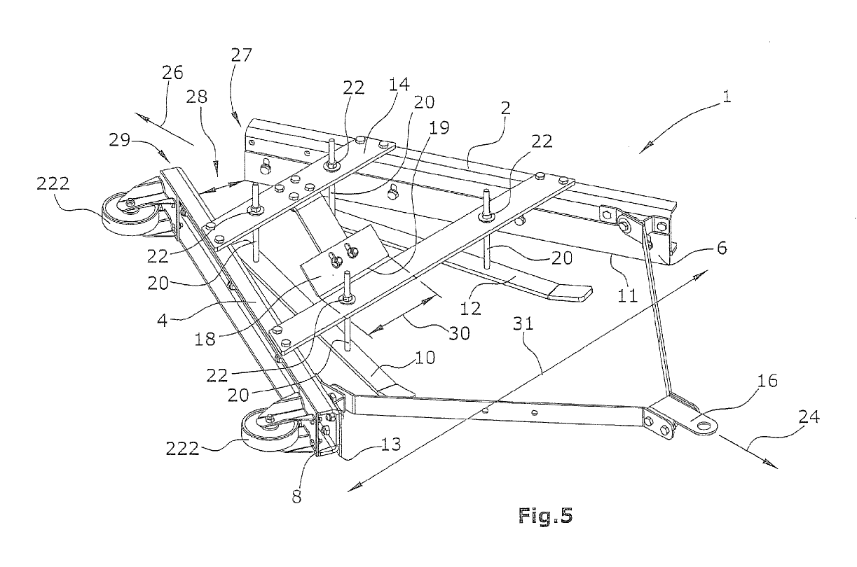

FIG. 5 shows a tennis court preparation device for scraping off tennis court surface layer material,

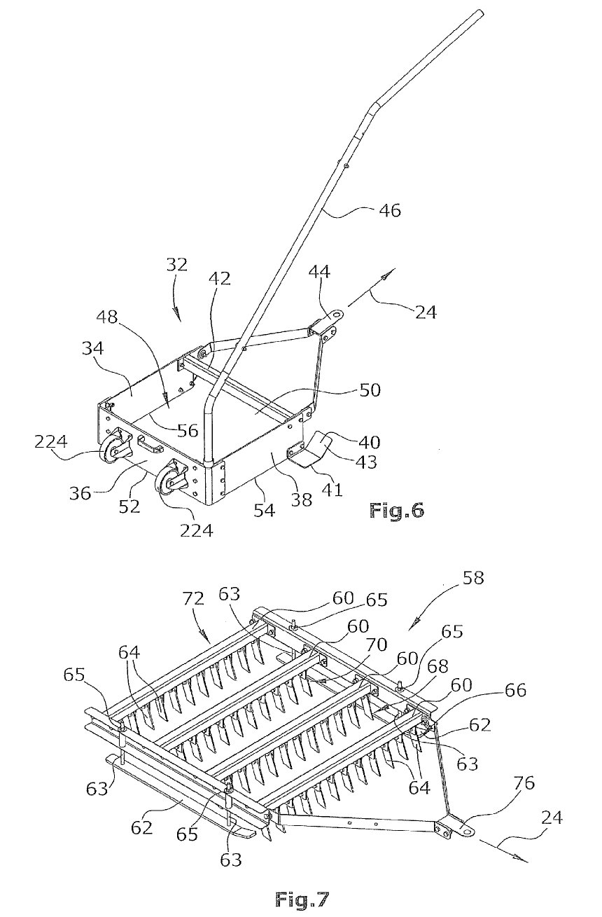

FIG. 6 shows a tennis court preparation device for collecting scraped-off tennis court surface layer material,

FIG. 7 shows a tennis court preparation device for preparation of a tennis court,

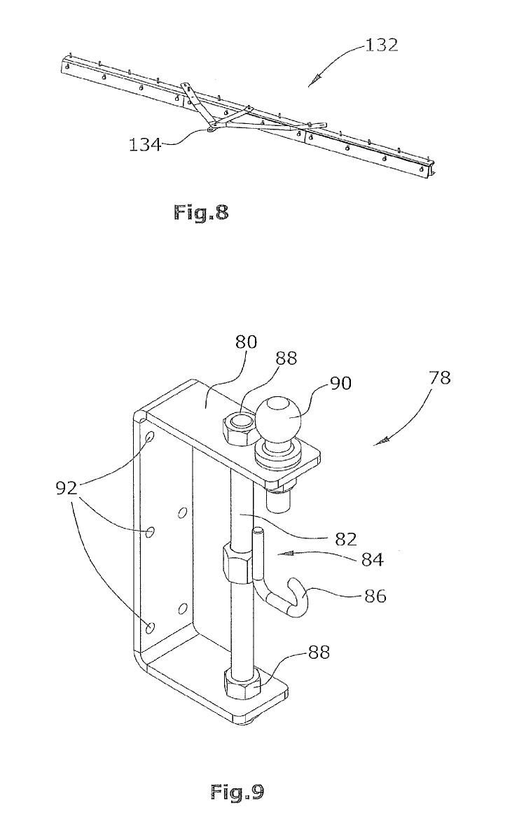

FIG. 8 shows a coupling device for coupling a tennis court preparation device to a traction vehicle,

FIG. 9 shows a tennis court preparation device for leveling the tennis court surface,

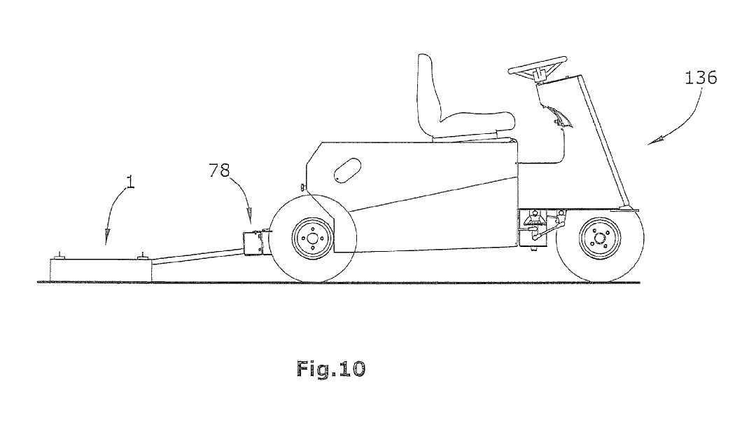

FIG. 10 shows a traction vehicle with a coupling device and a tennis court preparation device for scraping off tennis court surfaces.

Prior the start of a season, particularly in springtime, a cinder tennis court has to be refurbished and prepared. First, for this purpose, the largest tennis-court surface layer will be loosened. This can be performed by a tennis court preparation device according to FIG. 1. The tennis court preparation device 94 comprises three rows 96 of rod-shaped rod elements 98 which are attached to a frame 100. The frame 100 further comprises coupling device 102 by which the tennis court preparation device 94 can be coupled to a traction vehicle. With the aid of the tennis court preparation device 94, the uppermost tennis court surface layer can be easily loosened. Further, the tennis court preparation device 94 comprises an element 104 which comprises rolls 106. When the tennis court preparation device 94 is not needed anymore, it can be turned upside down and be rolled away with the aid of said element 104 and the rolls 106.

If, in winter, the tennis court has been too massively littered by e.g. twigs and leaves, it can be cleaned e.g. by a tennis court preparation device according to FIG. 2. The tennis court preparation device 108 according to FIG. 2 is a beam-shaped element which can be towed across the tennis court with the aid of a traction vehicle. For this purpose, the tennis court preparation device comprises a coupling device 110 by which the tennis court preparation device 108 can be coupled to a traction vehicle. Particularly in the area where the tennis court preparation device 108 is supported on the tennis court, the tennis court preparation device 108 can consist of rubber. With the aid of the tennis court preparation device 108, the tennis court can be cleaned prior to being treated by the tennis court preparation device 94 of FIG. 1, or, alternatively, the tennis court preparation device 108 can be hooked behind the tennis court preparation device 94 so that the loosening and the cleaning of the soil will be carried out simultaneously. Further, a dragnet, not shown, can be dragged behind.

In FIG. 3, there is again shown a tennis court preparation device 112 for loosening the uppermost layer of a tennis court surface. In contrast to the tennis court preparation device 94 according to FIG. 1, the tennis court preparation device 112 according to FIG. 3 comprises merely one row of rod-shaped scraper elements 114 attached to frame 116. The tennis court preparation device 112 further comprises a coupling device 118 by which the tennis court preparation device 112 can be coupled to a traction vehicle. The tennis court preparation device 112 can be used alternatively or additionally to the tennis court preparation device 94 according to FIG. 1.

FIG. 4 shows a tennis court preparation device for loosening a considerably compacted tennis court surface material. The tennis court preparation device 120 comprises a frame 126 of a particularly heavy design. In said frame 126, rod-shaped scraper elements 124 are mounted. Frame 126 is supported on the ground via support elements which, as illustrated, can be rolls 122. Further, frame 126 has connected to it a bar 128 provided with a handle grip 130. With the aid of handle grip 130, the tennis court preparation device 120 can be operated manually. Alternatively to handle grip 130, a coupling device for a traction vehicle can be provided. The particularly heavy weight of frame 126 makes it possible to loosen considerably compacted surface layers.

In case that the tennis court surface layer is already quite loose and is not littered, it will not be necessary to loosen the tennis court by one of the devices according to FIG. 1, 3 or 4 and/or to clean it by a device according to FIG. 2.

FIG. 5 shows the tennis court preparation device according to the invention for scraping off tennis court surface material. The tennis court preparation device comprises at least one frame 14. Provided on frame 14 are support elements 10,12 for supporting the frame on the tennis court surface that is to be prepared. Further, a coupling device 16 is provided for coupling to a traction vehicle. The tennis court preparation device 1 can be towed in the direction of travel 24 by means of the traction vehicle. Further, the tennis court preparation device comprises at least two main scraper elements 2,4 connected to the frame. The main scraper elements 2,4 are arranged relative to each other in such a manner that the distance between the two main scraper elements 2,4 tapers in a wedge-like shape in a direction 26 opposite to the direction of travel 24. The distance between the two main scraper elements is preferably measured in a direction orthogonal to the direction of travel 24. The two main scraper elements 2,4 are thus arranged in a wedge- or V-shape, with the pointed end being arranged in a direction 26 opposite to the direction of travel 24. At the rear end 27,29 of the main scraper elements 2,4 when viewed in the direction of travel, a gap 28 is arranged between the two main scraper elements 2,4. The scraped-off tennis court surface material is left lying in a trail defined by the gap.

Before said gap 28 when viewed in the direction of travel 24, an additional scraper element 18 is arranged which has a scraping width 30 corresponding at least to the width 22 of gap 28. In this manner, scraping is performed along the entire width 31 of the tennis court preparation device. The scraping width 30, the gap width 22 and the scraping width 31 are preferably measured in a direction orthogonal to the direction of travel 24.

The additional scraper element 18 extends substantially orthogonally to the direction of travel 24. This means that said edge 19 supported on the tennis court is particularly arranged substantially orthogonally to the direction of travel 24. Alternatively, the additional scraper element 18 can also extend at an angle different from 90° relative to the direction of travel 24. In this case, the edge 19 of additional scraper element 18 would extend obliquely.

In the illustrated exemplary embodiment, the additional scraper element 18 is arranged at such an angle relative to the tennis court to be prepared that, during movement in the direction of travel 24, the scraped-off tennis court surface material is caused to slide over the additional scraper element 18. Thus, the additional scraper element 18 is positioned at an oblique orientation. The additional scraper element 18 could also have any other design. However, it should have a working width, measured in a direction orthogonal to the direction of travel 24, which at least corresponds to the gap width 28.

The main scraper elements 2,4 each comprise scraping sheets 6,8 whose lower edges 11,13 will scrape off the tennis court surface material.

The scraping depth can be set particularly by adjusting the height between frame 14 and support elements 10,12. In the illustrated exemplary embodiment, this is effected by adjusting the nut 22 along the rod 20 so that the distance between support elements 10,12 and frame 14 is changed. In this manner, the scraping depth is settable.

The support devices 10,12 are arranged between the two main scraper elements 2,4. In this manner, the support elements 10,12 will leave no traces on the tennis court to be prepared.

As illustrated, the support elements 10,12 are skid elements. Alternatively, however, also rolls could be provided. The support elements 10,12 belong to a support device.

The tennis court preparation device 1 for scraping off tennis court surface material according to FIG. 5 can further comprise rolls 222 which are connected to at least one of the main scraper elements 2,4. When the tennis court is being treated by this tennis court preparation device 1 for scraping off tennis court surface material, these rolls 222 are not in contact with the tennis court surface. Only when the tennis court preparation device 1 shall be removed, the tennis court preparation device 1 can be turned upside down and carried off on said rolls 222.

FIG. 6 shows a tennis court preparation device for collecting scraped-off tennis court surface layer material. The tennis court preparation device 32 can be towed across a to-be-prepared tennis court by means of a traction vehicle. The tennis court preparation device 32 for collecting scraped-off tennis court surface layer material comprises at least one collection bin 48 which is delimited, laterally and in the rear area, by at least one side wall 34,36,38. In the illustrated exemplary embodiment, two side walls 34,38 are arranged laterally and one side wall 36 is arranged in the rear area. Alternatively, these side walls 34,36,38 can also be provided as an integral unit. In the illustrated exemplary embodiment, collection bin 48 has a rectangular cross-sectional shape. Alternatively, also a round shape could be provided.

The edges 52,54,56 of the side walls 34,36,38 are slideable on the scraped-off tennis court. Collection bin 48 is open in the front area 50 when viewed in the direction of travel 24 so that scraped-off material which in the direction of travel is arranged in front of collection bin 48 can be collected in collection bin 48. Collection bin 48 has no bottom. Further, collection bin 48 has no lid element. The tennis court preparation device 32 for collecting scraped-off tennis court surface layer material further comprises a coupling device 44 for coupling to a traction vehicle. Further, a rod element 46 is provided which is connected to collection bin 48. When viewed in the direction of travel 24, rod element 46 extends forward beyond the collection bin 48 to at least the coupling device 44. With the aid of rod element 46, the collection bin 48 can be tilted. In the illustrated exemplary embodiment, for this purpose, a pressure has to be applied on rod element 46. Collection bin 48 is tiltable in such a manner that the edge 52,54,56 of the at least one side wall 34,36,38 will at least in the rear area not contact the to-be-prepared tennis court anymore.

The tennis court preparation device 32 will be used after the tennis court preparation device 1 according to FIG. 5. The tennis court preparation device 1 according to FIG. 5 will leave a trail of scraped-off tennis court surface material, wherein the width of said trail is equal to the width of the gap 28 of the tennis court preparation device 1. The tennis court preparation device 32 will then be towed along said trail so that the tennis court surface material will be collected in the collection bin. The collected tennis court surface material can be driven to a collection site on the tennis court. Then, the driver of the traction vehicle, seated on the traction vehicle, can tilt the collection bin 48 with the aid of the rod element 46 and deposit the tennis court surface material on the collection site. The tennis court preparation device for collecting scraped-off tennis court surface layer material can also be arranged directly behind the tennis court preparation device 1 for scraping off tennis court surface material so that the scraping and the collecting will be performed in one working step.

The tennis court preparation device 32 for collecting scraped-off tennis court surface layer material further comprises tilting elements 40 laterally to the collection bin 48. In FIG. 6, only the tilting element 40 on one side is visible. When tilting the collection bin 48, collection bin 48 is supported on the tilting elements and, in this manner, no holes will be generated in the tennis court during tilting.

The at least one tilting element 40 preferably comprises at least two support faces 41,43, wherein, in the non-tilted state of collection bin 48, the first support face 41 is in contact with the tennis court. This is shown in FIG. 6. A second support face 43 is in contact with the tennis court in the tilted state of collection bin 48. It is also possible to provide still more support surfaces so that different support faces can support the collection bin 48 in different tilting positions.

Similar to the tennis court preparation device 1 for scraping off tennis court surface material according to FIG. 5, the tennis court preparation device 32 for collecting scraped-off tennis court surface layer material can be provided with rolls 222 for removal.

FIG. 7 shows a tennis court preparation device for preparation of a tennis court. The tennis court preparation device 58 for preparation of a tennis court can be towed across a tennis court in the direction of travel 24 with the aid of a traction vehicle. The tennis court preparation device 58 comprises at least one frame 60 and at least one coupling element 76 for coupling to the traction vehicle.

Further, there are provided support elements 62, connected to the frame, which—as in the illustrated exemplary embodiment—can be support skids. Further provided are at least two rows 66,68,70,72, arranged substantially orthogonally to the direction of travel, of mutually adjacent knife elements 64 which are connected to frame 60 and, when in a working position, will pierce into the tennis court. With the aid of said knife elements 64, slits can be generated in the ground so as to loosen the ground and to improve drainage. The tennis court preparation device 58 is used particularly after the scraping of the tennis court by the device according to FIG. 5. The knife elements 64 of the individual rows 66,68,70,72 can be arranged directly behind each other in the direction of travel 24 so that the knife elements 64 will be respectively guided in the same slits. Alternatively and preferably, the knife elements 64 are, as illustrated, arranged at an offset relative to each other so that, with the aid of the different rows 66,68,70,72, different slits can be generated in the ground.

The piercing depth of the knife elements 64 into the tennis court can be settable by adjustment of the height between said at least one support element 62 and the frame 60. The support elements 62 are connected to the frame 60 via the rod elements 63. By adjusting the nuts 65, the rod elements can be fastened to the frame 60 at different heights. In this manner, the height between support element 62 and frame 60 is adjusted.

In FIG. 8, there is shown a tennis court preparation device 132 for leveling a tennis court surface. The tennis court preparation device 132 is of a bar-shaped design and can be coupled to the traction vehicle by means of a coupling element 134 and then can be towed across the tennis court. The leveling of the tennis court will be carried out after the scraping of the top tennis court surface layer and, in the given case, after the loosening with the aid of the tennis court preparation device according to FIG. 7.

In FIG. 9, there is shown a coupling device 78 for coupling a tennis court preparation device to a traction vehicle. Said coupling device 78 comprises a frame element 80 which can be fastened to a traction vehicle. In the illustrated exemplary embodiment, the frame element 80 can be connected to the traction vehicle e.g. via bores 92 with the aid of screws.

The coupling device 78 further comprises a rod element 82 connected to frame element 80 and extending substantially orthogonally to the tennis court. In said rod element 82, an adjustment element 84 is arranged. Said adjustment element is adjustable in height along rod element 82. Adjustment element 84 comprises a connection device 86 adapted to have a tennis court preparation device coupled to it. The illustrated rod element 82 is preferably provided in the form of a threaded bar, and the adjustment element 84 preferably comprises a nut. The nut can be adjusted in height along the threaded bar by rotating. Preferably, connection device 86 is a hook element, as is the case in the illustrated exemplary embodiment. In this manner, the height of connection device 86 can be easily adjusted and optimally adapted to the respective tennis court preparation device that is to be coupled. Thus, the tennis court preparation devices will not get jammed.

Shown in FIG. 10 is a traction vehicle which can be e.g. a small ride-on tractor, together with a coupling device 78 fastened to the traction vehicle. Coupled to the coupling device 78 is a tennis court preparation device 1 for scraping off tennis court surfaces. However, there can be coupled also other tennis court preparation devices which are shown e.g. in FIGS. 1 to 4 and respectively 6 to 9. Also, a plurality of tennis court preparation devices can be coupled behind each other.

1-18. (canceled)

19. A tennis court preparation device for scraping tennis court surfaces, which can be pulled across a tennis court in a direction of travel by a traction vehicle, comprising:
at least one frame
and at least one support device for supporting the frame on the tennis court surface that is to be prepared, wherein at least one coupling device is provided for coupling to a traction vehicle,
at least two first scraper elements connected to the frame are provided, which are arranged relative to each other in such a way that the distance between the two first scraper elements tapers in the direction opposite to the direction of travel,
a gap is left between the two first scraper elements at the rear ends of the first scraper elements as viewed in the direction of travel, so that the scraped-off tennis court surface material is left in a trail formed by the gap, and
in front of the gap as viewed in the direction of travel, a second scraper element is arranged, having a scraping width corresponding to at least the width of the gap.

20. The tennis court preparation device according to claim 19, wherein the second scraper element extends substantially orthogonally to the direction of travel.

21. The tennis court preparation device according to claim 19, wherein the second scraper element extends at such an angle relative to the tennis court to be prepared that, during movement in the direction of travel, the scraped-off tennis court material is caused to slide over the second scraper element.

22. The tennis court preparation device according to claim 19, wherein the scraping depth is settable by adjustment of the distance between the support device and the frame.

23. The tennis court preparation device according to claim 19, wherein the at least one support device is arranged between the first scraper elements.

24. The tennis court preparation device according to claim 19, wherein the at least one support device comprises two support elements which preferably are support skids.

25. A tennis court preparation device for collection of scraped-off tennis court surface material, said tennis court preparation device being towable in the direction of travel across a to-be-prepared tennis court by means of a traction vehicle, comprising:
at least one collection bin which is delimited, laterally and in the rear area when viewed in the direction of travel, by at least one side wall, said at least one side wall being slideable by an edge on the scraped-off tennis court, the collection bin being open in the front area when viewed in the direction of travel, so that scraped-off material arranged in front of the collection bin when viewed in the direction of travel can be collected in the collection bin,
at least one coupling element for coupling to a traction vehicle, and
at least one bar element connected to the collection bin, said rod element, when viewed in the direction of travel, extending forward beyond the collection bin to at least the coupling device, wherein, with the aid of the bar element, the collection bin is tiltable so that said edge of said at least one side wall in the rear area does not contact the to-be-prepared tennis court anymore.

26. The tennis court preparation device according to claim 25, wherein at least one tilting element is provided which, when viewed in the direction of travel, is arranged laterally adjacent to the collection bin, wherein the collection bin, when tilted, can be supported on said at least one tilting element.

27. The tennis court preparation device according to claim 25, wherein two tilting elements are provided, each of them being arranged, when viewed in the direction of travel, laterally adjacent to the collection bin, with a first of the two tilting elements being arranged on the first side of the collection bin and the second of the two tilting elements being arranged on the second side of the collection bin.

28. The tennis court preparation device according to claim 26, wherein said at least one tilting element comprises at least two support faces, the first support face being in contact with the tennis court in the non-tilted state of the collection bin and the second support face being in contact with the tennis court in the tilted state of the collection bin.

29. A tennis court preparation device for preparing a tennis court, which is towable in the direction of travel across a tennis court by means of a traction vehicle, comprising:
at least one frame,
at least one coupling element for coupling to the traction vehicle,
at least one support element connected to the frame,
at least two rows, arranged orthogonally to the direction of travel, of mutually adjacent knife elements which are connected to the frame and, when in a working position, are operative to pierce into the tennis court, and
the piercing depth being settable by adjustment of the height between said at least one support element and the frame.

30. A coupling device for coupling a tennis court preparation device to a traction vehicle which can be driven across a tennis court to be prepared, comprising:
a frame element adapted to be fastened to a traction vehicle,
a bar element connected to the frame element and extending substantially orthogonally to the tennis court, and
an adjustment element connected to the bar element and being adjustable in height along the bar element, said adjustment element comprising a connection device adapted to have a tennis court preparation device coupled to it.

31. The coupling device according to claim 30, wherein the bar element is a threaded bar.

32. The coupling device according to claim 31, wherein the adjustment element comprises a nut.

33. The coupling device according to claim 30, wherein the connection device is a hook element.
